(19) United States
(12) Patent Application Publication
(10) Pub. No.: US 2011/0014406 A1
(43) Pub. Date: Jan. 20, 2011

(54) SHEET MATERIAL EXHIBITING INSULATING AND CUSHIONING PROPERTIES

(76) Inventors: James Clyde Coleman, Ogden, UT (US); Kurt L. Gamill, Layton, UT (US)

Correspondence Address: Sally J. Brown;AUTOLIV ASP, INC., 3350 Airport Road, Ogden, UT, 84405, US

(21) Appl. No.: 12/503,737

(22) Filed: Jul. 15, 2009

(51) Int. Cl. B32B 1/06; D03D 15/00; D03D 13/00; B32B 38/00; B32B 38/10

(52) U.S. Cl. 428/36.2; 442/181; 442/203; 428/72; 156/148

(57) ABSTRACT

An article exhibiting insulating or cushioning properties includes a multi-layered one-piece woven textile having opposed first and second faces and a continuous circumscribing peripheral edge therebetween. A first outer surface of the article is defined by a fluid-impervious laminate first sheet secured to the first face of the textile that includes a first fabric carrying a fluid-impervious melt-adhesive sealing film. A second outer surface of the article is defined by a fluid-impervious laminate second sheet secured to the second face of the textile that includes a second fabric carrying a fluid-impervious melt-adhesive sealing film. A continuous fluid-impervious seal is formed between the first sheet and the second sheet circumscribes the peripheral edge of the textile. The sealing film of each sheet is bonded to a respective face of the textile. The article is suitable for incorporation into a light-weight construction configured for rugged outdoor use.

### BACKGROUND OF THE INVENTION

1. Field of the Invention

The present invention pertains to the type of sheet material that is capable of serving as insulation or cushioning in an article of manufacture. More particularly, the present invention relates to light-weight constructions configured for rugged outdoor use, such as personal attire, ground covers, pillows, tenting, tarps, blankets, windscreens, watercraft, and containers for equipment or supplies, any of which may benefit from the incorporation of sheet material that exhibits insulating or cushioning properties.

2. Background

Activities in an outdoor environment frequently entail the use of specialized equipment that enables an individual to endure in the face of harsh conditions. To fend off extremes of cold or heat, to live comfortably on hard, rocky ground, and to deal with wind and precipitation, constructions such as personal attire, ground covers, pillows, tenting, tarps, blankets, windscreens, watercraft, and containers for equipment or supplies incorporate materials that exhibit insulating or cushioning properties.

Insulation and cushioning may take the form of pads of non-woven fibers enclosed for enhanced mechanical integrity in textile shells. Quilted ground coverings, quilted blankets, and quilted items of personal attire are examples. Alternatively, to introduce insulative or cushioning properties into a construction, loose synthetics, such as fleece or chopped polymer fibers, or natural materials, such as cotton fibers, animal fur, or bird down, are also enclosed in textile shells.

These approaches have drawbacks. Insulation and cushioning of the types described are relatively heavy and usually quite bulky. Such qualities contribute to transport challenges, to crowding in close quarters, and to dangerously awkward degrees of lost personal mobility.

It has been observed, however, that among the more light-weight of these approaches, it is actually the air in the loft of the material employed that supplies most of the desired insulating barrier to heat transfer. Air trapped among the unwoven constituent fibers in those materials may even contribute protective cushioning. The constituent fibers do not themselves so much insulate or cushion. Rather the constituent materials sustain therealong spaces that are filled with air. It is to enhance the air content of constructions employing such unwoven materials that the fluffing of those constructions is recommended prior to use. Whether by weight or by volume, few configurations of the constituents of unwoven materials are able to exceed the per unit effectiveness of common air as insulation or as cushion.

A material that is, by contrast, of unitary construction is cured open-cell foam. Bodies made of open-cell foam are enclosed within valved, air-impervious shells, thereby to function as air-filled cushioning.

### BRIEF SUMMARY OF THE INVENTION

In accord with teachings of the present invention, a sheet material having utility as insulation or cushioning in an article of manufacture includes a fluid-impervious first layer defining a first outer surface of the sheet material, a fluid-impervious second layer defining a second outer surface of the sheet material on the opposite side of the sheet material from the first outer surface, and a matrix of woven threads. The matrix has opposed first and second faces and is sandwiched between the first layer and the second layer with the first face of the matrix secured to the first layer and the second face of the matrix secured to the second layer. The matrix is capable of housing in open-cell fashion among the threads thereof a fluid isolated by the first layer and the second layer from the exterior of the sheet material. An example of such a matrix is a triple-layer weave of threads. The fluid typically is a gas, such as ambient air.

The first layer of the sheet material includes a fluid-impervious melt-adhesive sealing film carried on a side of a first fabric. The sealing film of the first layer is bonded to the first face of the matrix. The second layer of the sheet material includes a fluid-impervious melt-adhesive sealing film carried on a side of a second fabric. The sealing film of the second layer is bonded to the second face of the matrix.

According to another aspect of the present invention, an article exhibiting insulating or cushioning properties includes a multi-layered one-piece woven textile having opposed first and second faces and a continuous peripheral edge therebetween circumscribing the textile. A fluid-impervious laminate first sheet is secured to the first face of the textile, a fluid-impervious laminate second sheet is secured to the second face of the textile, and a continuous fluid-impervious seal between the first sheet and the second sheet circumscribes the peripheral edge of the textile. The first sheet defines a first outer surface of the article, while the second sheet defines a second outer surface of the article. The article is suitable for incorporation into a light-weight construction configured for rugged outdoor use and chosen from among the group of constructions including personal attire, ground covers, pillows, tenting, tarps, blankets, windscreens, watercraft, and containers for equipment or supplies.

The present invention also includes methods for manufacturing a light-weight construction configured for rugged outdoor use and exhibiting insulating or cushioning properties. One embodiment of such a method includes the steps of preparing a work piece of woven threads that has opposed first and second faces and a continuous peripheral circumscribing edge therebetween, encasing the work piece in an interior space within an air-tight enclosure, and effecting fluid access to the interior space.

The step of preparing includes the steps of weaving a one-piece triple-layer textile and of cutting the textile into a predetermined configuration suitable for use in the construction.

The step of encasing the work piece in an air-tight enclosure comprises the steps of securing an air-impervious first layer to the first face of the work piece with a circumscribing margin portion of the first layer extending beyond the peripheral edge of the work piece, securing an air-impervious second layer to the second face of the work piece with a circumscribing margin portion of the second layer extending beyond the peripheral edge of the work piece, and continuously sealing the margin portion of the first layer to the margin portion of the second layer. The step of securing the first layer involves applying an air-impervious melt-adhesive sealing film to a side of a first fabric to produce the first layer, and bonding the first layer to the first face of the work piece using the sealing film. Similarly, the step of securing the second layer involves applying an air-impervious melt-adhesive sealing film to a side of a second fabric to produce the second layer, and bonding the second layer to the second face of the work piece using the sealing film.

The step of effecting fluid access to the interior space comprises the steps of establishing a passageway communicating between the interior space and the exterior of the construction, and installing in the passageway a selectively operable valve capable of assuming an open condition wherein fluid communication is afforded between the exterior of the construction and the interior space and a closed condition wherein fluid in the interior space is isolated from the exterior of the construction.

### BRIEF DESCRIPTION OF THE SEVERAL VIEWS OF THE DRAWINGS

In order that the manner in which the above-recited and other features and advantages of the present invention are obtained will be readily understood, a more particular description of the present invention briefly described above will be rendered by reference to specific embodiments thereof that are illustrated in the appended drawings. Understanding that these drawings depict only typical embodiments of the present invention and are not therefore to be considered to be limiting of the scope thereof, the present invention will be described and explained with additional specificity and detail through the use of the accompanying drawings in which:

FIG. 1 is a perspective view of a sportsperson outdoors wearing an embodiment of a light-weight vest incorporating teachings of the present invention and thereby exhibiting advantageous insulating and cushioning properties;

FIG. 2 is a broken cross section of the vest of FIG. 1 taken along section line 2-2 therein;

FIGS. 3A-3F are a series of schematic diagrams depicting steps used to weave a textile that, according to teachings of the present invention, finds utility in manufacturing an article, such as the vest of FIG. 1;

FIG. 4 is a plan view of one face of a textile produced by the weaving steps illustrated in FIGS. 3A-3F;

FIG. 5 is an enlarged detail of the portion of FIG. 2 identified by detail arrows 5-5 therein, incorporating as the matrix thereof the fabric of FIG. 4, which as included in FIG. 5 is presented as a cross section of the fabric taken along section line 5-5 in FIG. 4;

FIG. 6 is a schematic diagram illustrating an embodiment of a method embodying the present invention for manufacturing an article, such as a component of the vest of FIG. 1; and

FIG. 7 is a flow chart depicting steps in the method of FIG. 6.

### DETAILED DESCRIPTION OF THE INVENTION

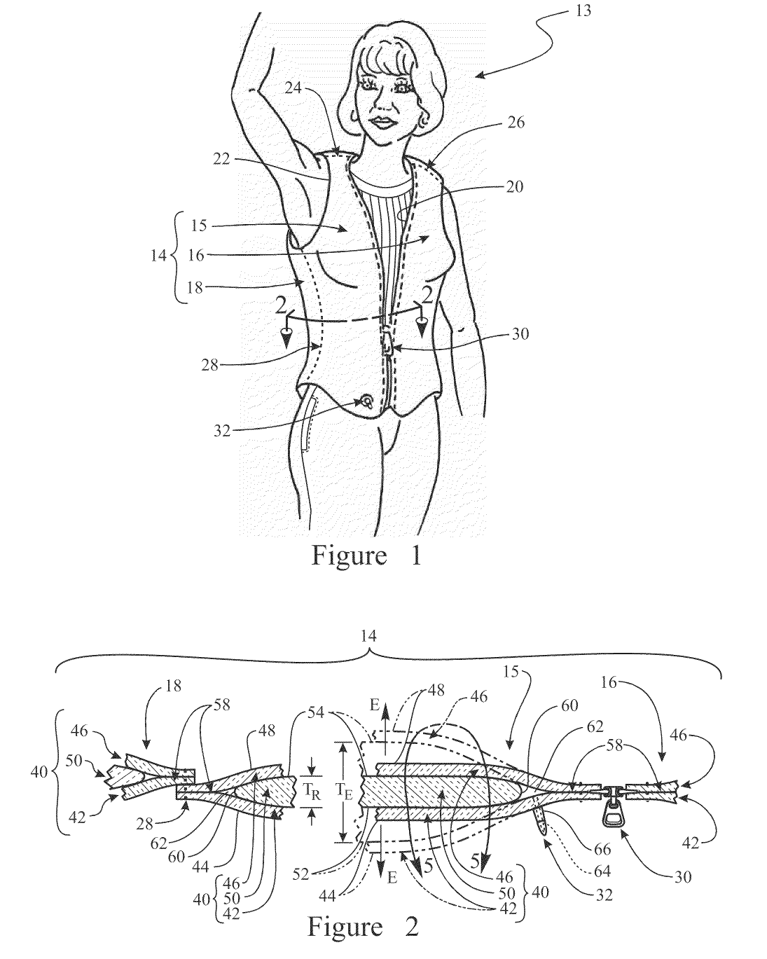

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the present invention, as represented in FIGS. 1-7, is not intended to limit the scope of the present invention, as claimed, but is rather representative of typical embodiments of the present invention.

FIG. 1 is a perspective view of a sportsperson 13 outdoors wearing a vest 14 that incorporates teachings of the present invention. Consequently, vest 14 is a light-weight construction that nonetheless exhibits advantageous insulating and cushioning properties. Vest 14 typifies constructions configured for rugged outdoor use that benefit from teachings of the present invention, constructions such as personal attire, ground covers, pillows, tenting, tarps, blankets, windscreens, watercraft, and containers for equipment or supplies. Yet, the teachings of the present invention have useful applicability in various other manufactured goods wherein light-weight insulating or cushioning is desired.

Vest 14 includes a first front panel 15, a second front panel 16, and a back panel 18 that are stitched together at various variously peripheral edges thereof to produce a garment having a neck opening 20 and an armhole 22. A second armhole of vest 14 is not visible in FIG. 1. Shoulder seams 24 and 26 can be seen connecting an upper portion of first front panel 15 to back panel 18 between neck opening 20 and armhole 22. A side seam 28 connects a side portion of first front panel 15 to back panel 18 below armhole 22. A zipper 30, or other selectively fastenable means, is used to close vest 14 about sportsperson 13 by releasably securing first front panel 15 to second front panel 16 below neck opening 20. At the bottom of first front panel 15 near zipper 30, vest 14 is provided with a selectively operable valve 32 the function of which will be discussed subsequently.

FIG. 2 is a broken cross-sectional view of first front panel 15 of vest 14 taken along section line 2-2 in FIG. 1. Accordingly, FIG. 2 affords an initial overview of the structure of the sheet material from which the panels of vest 14 are fabricated.

First front panel 15, like the other panels of vest 14, is constructed from a sheet material 40 that has utility as insulation or cushioning. Sheet material 40 includes a fluid-impervious first layer 42 that defines a first outer surface 44 of sheet material 40 and a fluid-impervious second layer 46 that defines a second outer surface 48 of sheet material 40 on the opposite side thereof from first outer surface 44.

When sheet material 40 is formed into first front panel 15 and assembled into vest 14, first layer 42 and first outer surface 44 of sheet material 40 are oriented outwardly from sportsperson 13, toward the outdoor environment in which sportsperson 13 would wear vest 14. For this reason, first layer 42 exhibits qualities that are of advantage in encountering outdoor environments. On the other hand, second layer 46 and second outer surface 48 of sheet material 40 are oriented inwardly, toward the torso of sportsperson 13, and second layer 46 exhibits qualities that are beneficial at that location. These particular qualities of first layer 42 and second layer 46 will be mentioned subsequently in the context of a discussion of the manufacture of first front panel 15.

Sandwiched between first layer 42 and second layer 46 is a matrix 50 of woven threads. A first face 52 of matrix 50 engages and is secured to first layer 42, while an opposed second face 54 of matrix 50 engages and is secured to second layer 46. Under normal circumstances, matrix 50 is a thin, relatively dense configuration of woven threads having a resting thickness T_{R} measured perpendicular to the planar extent thereof between first face 52 and second face 54.

Due to the particular manner by which matrix 50 is fabricated and incorporated into sheet material 40, matrix 50 is capable of a controlled volumetric expansion in which the distance between first face 52 and second face 54 increases into an engorged thickness T_{E}. This is suggested in FIG. 2 by engorgement arrows E and by the depiction as an overlay in phantom on the right side of FIG. 2 of a thusly engorged version of sheet material 40. Engorged thickness T_{E} is appreciably larger than resting thickness T_{R} thickness.

The engorgement of sheet material 40 is caused by a viscous fluid isolated between first layer 42 and second layer 46 from the exterior of sheet material 40 that is introduced among the woven threads of matrix 50. The fluid introduced percolates through the fibers of matrix 50, lending loft to matrix 50, much in the manner that air will fill cured open-cell foam. In the case of sheet material, such as sheet material 40 used in an article of outdoor clothing, it is most likely that the viscous fluid used to provide loft in matrix 50 will be a gas, such as ambient air. An example of a material that functions in the manner described above for matrix 50 is a one-piece, triple-layer textile. The manufacture of a textile of this type will be discussed in due course.

A continuous fluid-impervious seal 58 is formed between first layer 42 and second layer 46 circumscribing the peripheral edge 60 of matrix 50. This results in the creation within sheet material 40 of an interior space 62 that houses matrix 50 and that is isolated from the exterior of sheet material 40. Selectively controllable fluid communication is established between interior space 62 and the exterior of first front panel 15 by way of a fluid passageway 64 that extends longitudinally through the stem 66 of valve 32. Valve 32 controls the access through passageway 64 to interior space 62.

Valve 32 may assume an open condition in which fluid communication is afforded between the exterior of first front panel 15 and interior space 62, or valve 32 is capable of assuming a closed condition in which fluid in interior space 62 is completely isolated from the exterior of first front panel 15. If fluid is to be added to interior space 62, as for example to enhance the loft of matrix 50, or if fluid is to be extracted from interior space 62, as for example to permit vest 14 to be compressed for storage, valve 32 is manipulated into the open condition thereof. When the loft of matrix 50 is satisfactory and is to be maintained, valve 32 is manipulated into and left in the closed condition thereof.

In a construction, such as vest 14 that includes several distinct panels possessed of these properties, each panel is provided with its own respective valve, or the interior spaces in the individual panels are placed in fluid communication with each other by including in the construction internal fluid passageways that interconnect those interior spaces. Such passages traverse the locations, such as at first shoulder seam 24, at second shoulder seam 26, and at side seam 28, where the panels of vest 14 are attached to each other. Alternatively, an entire construction may be so designed as to include only a single panel that encloses a single, extensive interior space.

A better understanding of the nature and the manufacture of an article, such as first front panel 15 that incorporates a textile that functions in the manner of matrix 50, commences with an understanding of how a one-piece, triple-layer textile is actually produced.

By way of background, a woven fabric is made up of a field of parallel, generally coplanar warp threads that are traversed perpendicularly by weft threads that are generally parallel to each other. Each weft thread crosses each warp thread of the fabric, and visa versa.

During manufacturing, all of the warp threads for a future fabric are maintained under tension extending longitudinally through a loom. The warp threads form a foundation from which a fabric arises as a result of the weaving of successive weft threads across the loom and through the field of warp threads. Weft threads are advanced individually among the warp threads, passing over some and under others in a pattern that is particular to each individual weft thread. The weaving pattern of a given weft thread usually differs from the weaving pattern associated with the weft thread that immediately precedes it in the fabric.

Unwoven warp threads on a loom normally occupy a coplanar relationship that defines a base level in the loom. Weft threads passing across the field of unwoven warp thread do so in a weft plane that overlies warp threads that are at the base level. All unwoven warp threads do not, however, remain at the base level during the transit of a weft thread through the warp thread field. A typical loom includes a jacquard mechanism that extends across the width of the loom over the field of the unwoven warp threads. During each transit of a weft thread across the field of unwoven warp threads, the jacquard mechanism lifts individual warp threads out of the warp thread field into an elevated level in the loom that is above the weft plane. A weft thread thus passes over the warp threads at the base level and under warp threads at the elevated level. In this manner, the jacquard mechanism implements the weaving pattern for each particular weft thread.

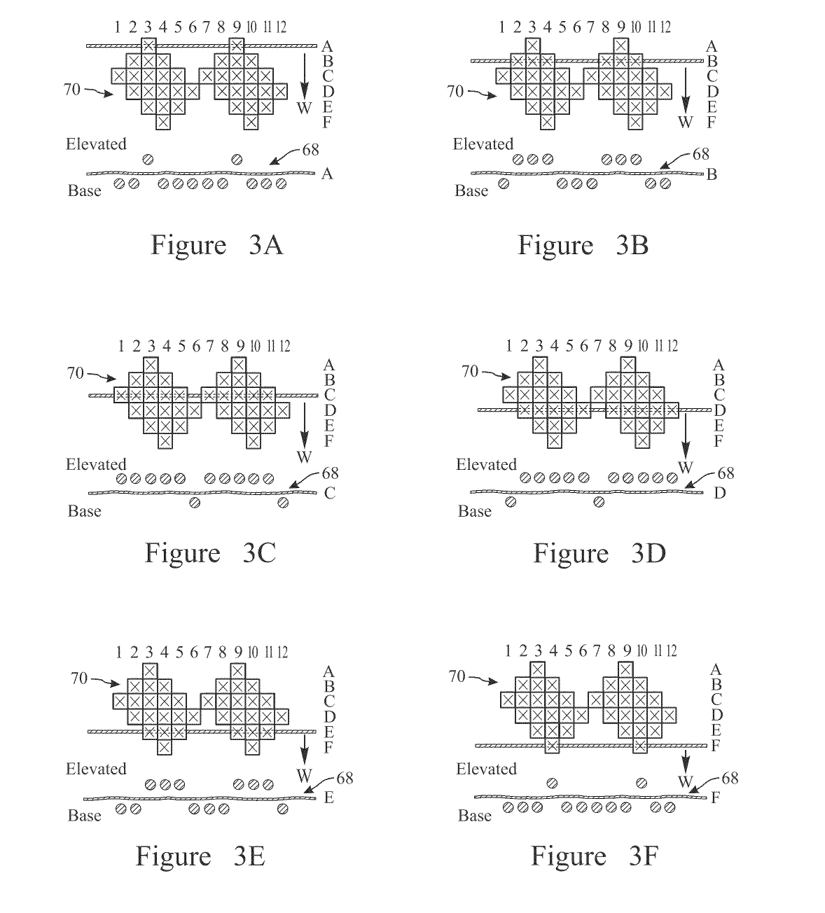

FIGS. 3A-3F are a series of schematic diagrams depicting typical steps used to weave a textile that functions in the manner of matrix 50 in an article, such as first front panel 15, or in a construction, such as vest 14. Each drawing in the series depicts a single weaving pattern in a series of six different weaving patterns that cumulatively make up a weaving cycle that is repeated again and again in producing a one-piece, triple-layer textile.

Sequenced numerals along the top of each drawing in the series identify warp threads 1-12, or the locations of individual of warp threads 1-12 in the full warp thread field. In the lower portion of each drawing in the series, warp threads 1-12 appear in cross section in a loom 68. In each depiction of loom 68, the weft plane is occupied by a single, lettered weft thread, weft thread A in FIG. 3A, weft thread B in FIG. 3B, and so on through weft thread F in FIG. 3F Some of warp threads 1-12 are depicted as being at the base level of loom 68, while the others are depicted in the elevated level of loom 68. The cross sections of loom 68 thus depict the actual positions assumed by warp threads during the transit of a specific weft thread across the warp thread field between the base level and the elevated level of loom 68.

The weaving patterns for all of weft threads A-F collectively are presented schematically at the top of each drawing in the series in the form of a jacquard pattern 70, a two-dimensional grid in which columns correspond to warp threads and rows correspond to weft threads. In jacquard pattern 70, a box occupied by the letter “X” indicates that the warp thread corresponding to the position of the box in the grid is to be in the elevated level, when the weft thread corresponding to the position of the box in the grid is in transit across the warp thread field. The particular weft thread pattern shown in loom 68 in each drawing in the series corresponds in the associated jacquard pattern 70 thereabove to the lettered row through which a braided horizontal bar is disposed. The progression of weaving from weft thread A through weft thread F is suggested by an weaving arrow W.

Thus, in FIG. 3A, during the transit of weft thread A across the warp thread field, warp threads 3 and 9 are at the elevated level, while the rest of the warp threads remain at the base level. Next, as shown in FIG. 3B, during the transit of weft thread B across the warp thread field, warp threads 2-4 and 8-10 are at the elevated level, and warp threads 1, 5-7, 11 and 12 are at the base level. Weaving continues in FIG. 3C, where jacquard pattern 70 and the cross section of loom 68 indicate that during the the transit of weft thread C across the warp thread field, warp threads 1-5 and 7-11 are at the elevated position, while only warp thread 6 and 12 remain at the base level.

In FIG. 3D, the weaving pattern for weft thread D is revealed to require that warp threads 2-5 and 8-12 be in the elevated level, and only warp threads land 7 be in the base level. Next, as shown in FIG. 3E, the transit of weft thread E across the warp thread field takes place with warp threads 3-5 and 9-11 at the elevated level and warp threads 1, 2, 6-8, and 12 at the base level. Finally, a full weaving cycle concludes with the weaving pattern for weft F, in which only warp threads 4 and 10 are at the elevated level, while the rest of the warp threads remain at the base level.

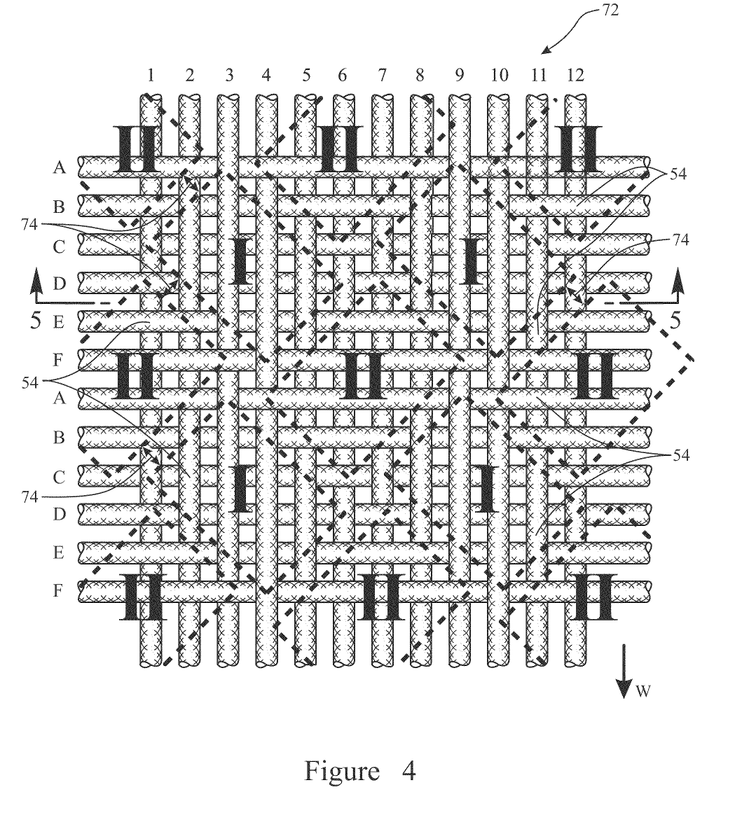

The weaving process continues by repeating the weaving cycle depicted collectively in FIGS. 3A-3F. When a second such cycle has been completed, the result is a one-piece, triple-layer textile 72 that is shown in FIG. 4. The face of textile 72 shown in FIG. 4 corresponds to second face 54 of matrix 50 in FIG. 2 and is accordingly so labeled in FIG. 4.

Warp threads 1-12 and two sets of weft threads A-F at the periphery of textile 72 correlate to the weaving steps illustrated in FIGS. 3A-3F. Second face 54 of textile 72 exhibits an interlocking array of rectangular regions in which adjacent warp threads or adjacent weft threads remain as a group on the second face 54. Several such regions are marked out in an overlay by heavy dashed lines and identified in equally heavy roman characters as either a region I or a region II.

Regions I and regions II are oriented at 45 degrees to the warp and weft of textile 72, but the elongated aspect of regions I and regions II are oriented at 90 degrees to each other. Regions I and regions II thus form a tessellating array that covers second face 54 of textile 72 and matrix 50.

In regions I, six adjacent warp threads are presented on second face 54 of textile 72, either warp threads 1-6 in some of regions I, or warp threads 7-12 in the others. Correspondingly, below the warp threads in regions I, adjacent weft threads A-F are presented on the face of textile 72 that is not visible in FIG. 4. The face of textile 72 not visible in FIG. 4 corresponds to first face 52 of matrix 50 in FIG. 2 and will accordingly be so referred to hereinafter and so labeled in subsequent drawings. When the opposed faces of textile 72 at any region I are sandwiched between and secured to respective fluid-impervious layers, such as first layer 42 and second layer 46 in FIG. 2, a fluid entered into the threads of that region I causes a controlled volumetric expansion of that region I in which the distance between first face 52 and second face 54 increases, and the insulative and cushioning capacity of the body of textile 72 there is enhanced.

In all of regions II, the six adjacent weft threads are presented on the second face 54 of textile 72 in the order of weft threads D-F followed by weft threads A-C. Correspondingly, below those weft threads, an equal number of adjacent warp threads are presented on the first face 52 of textile 72 that is not visible in FIG. 4. When the opposed faces of textile 72 at any region II are sandwiched between and secured to respective fluid-impervious layers, such as first layer 42 and second layer 46 in FIG. 2, a fluid entered into the threads of that region II causes a controlled volumetric expansion of that region I in which the distance between first face 52 and second face 54 increases, and the insulative and cushioning capacity of the body of textile 72 there is enhanced.

Under such conditions, regions I and regions II function like the quilting in a sheet material that is filled with loose fiber, batting, or a natural filler. Textile 72 is, however, lighter than such a quilted sheet material, as no fiber, batting, or filler is carried in the regions I and regions II to the sustain loft produced in textile 72 by the introduction of air into the interior space therein.

Between adjacent of regions I and regions II are transition corridors 74, areas of textile 72 in which groups of adjacent warp threads exchange faces of textile 72 with groups of adjacent weft threads. The fluid that provides loft in textile 72 percolates through transition corridors 74 more gradually than the fluid fills regions I and regions II. Thus, transition corridors 74 retard the rate of heat transfer among individual of regions I and regions II, enhancing the insulative capability of textile 72. Transition corridors 74 serve also as areas of textile 72 in which bending is facilitated, keeping textile 72 flexible, even when inflated to enhance loft.

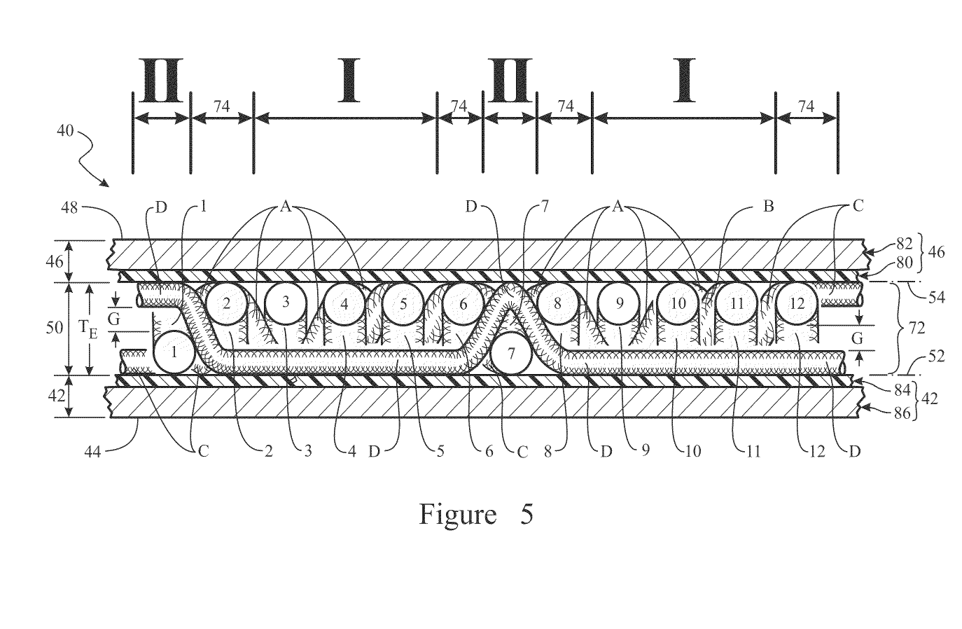

FIG. 5 will now be used to provide a deeper understanding of the structure of sheet material 40 than was possible earlier in referring to FIG. 2. Initially, the nature of FIG. 5 must be clearly established.

FIG. 5 is a detail of the engorged version of sheet material 40 shown in phantom in FIG. 2, and in particular of the portion of that engorged version of sheet material 40 that is identified by detail arrows 5-5 in FIG. 2. In FIG. 5, however, constituents of first layer 42 and of second layer 46 of sheet material 40 are shown; and as matrix 50 of sheet material 40. FIG. 5 incorporates the warp and weft thread details of textile 72 that are acquired by taking a cross section of textile 72 along section line 5-5 in FIG. 4, between the upper weft thread D and the upper weft thread F, looking upwardly in FIG. 4 in a direction opposite that suggested by weaving arrow W.

In FIG. 5, second layer 46 of sheet material 40 is seen to include a fluid-impervious melt-adhesive sealing film 80 that is carried on a side of a fabric 82. Sealing film 80 is bonded to second face 54 of matrix 50, which in FIG. 5 is shown as textile 72. Thus, sealing film 80 engages and is secured to what in FIG. 5 are the uppermost portions of various of warp threads and the weft threads of textile 72. From left to right in FIG. 5, these are weft thread D, warp threads 2-6, weft thread D again, warp threads 8-12, and finally weft thread C. Other than weft thread C, these elements of textile 72 are located on second face 54 thereof immediately adjacent to the plane of section line 5-5 in FIG. 4. The portion of weft thread C seen as being bonded to second layer 46 in FIG. 5 is disposed, like the entirety of weft thread C itself, at a distance from the plane of section line 5-5 in FIG. 4.

The bonding of sealing film 80 to these elements of textile 72 is superficial in the sense that only the uppermost surfaces of those elements are attached thereby to second layer 46. Adjacent to the plane of section line 5-5 in FIG. 4, second layer 46 is not, for example, attached to warp thread 1 or to warp thread 7 both of which are below weft thread D. Neither is second layer 46 attached to weft thread D where weft thread D is below warp threads 2-6 or where weft thread D is below warp threads 8-12.

Additionally in FIG. 5, first layer 42 of sheet material 40 is seen to include a fluid-impervious melt-adhesive sealing film 84 that is carried on a side of a fabric 86. Sealing film 84 is bonded to first face 52 of matrix 50, which in FIG. 5 is also identified as textile 72. Thus, sealing film 84 engages and is secured to what in FIG. 5 are the lowermost portions of various of warp threads and the weft threads of textile 72. From left to right in FIG. 5, these are weft thread C, warp thread 1, weft thread D, warp thread 7, and finally weft thread D again. Other than weft thread C, these elements of textile 72 are located on first face 52 thereof immediately adjacent to the plane of section line 5-5 in FIG. 4. The portion of weft thread C seen as being bonded to first layer 42 in FIG. 5 is disposed, like the entirety of weft thread C itself, at a distance from the plane of section line 5-5 in FIG. 4.

The bonding of sealing film 84 to these elements of textile 72 is superficial in the sense that only the lowermost surfaces of those elements are attached thereby to first layer 42. First layer 42 is not, for example, attached to weft thread D where weft thread D is above warp thread 1 or above warp thread 7. Neither is first layer 42 attached to, warp threads 2-6 or to warp threads 8-12 where these are above weft thread D.

With first layer 42 and second layer 46 of sheet material 40 secured in this superficial manner to the opposed faces of textile 72, the triple-layer woven nature of textile 72 permits a fluid introduced among threads of textile 72 to separate first layer 42 and the elements of textile 72 attached thereto from second layer 46 and the elements of textile 72 attached thereto. The resting thickness T_{R} of matrix 50 and textile 72 shown in FIG. 2 increases into the engorged thickness T_{E} shown in FIG. 5 as first layer 42 and the elements of textile 72 attached thereto move away from second layer 46 and the elements of textile 72 in accommodation of the fluid. A gap G filled with the fluid arises between the elements of textile 72 that are attached to first layer 42 and the elements of textile 72 that are attached to second layer 46. Throughout the expanse of textile 72, the warp threads and the weft threads of textile 72 change from one group of elements, those attached to first layer 42, into the other group of elements, those attached to second layer 46. In this manner, the warp threads and the weft threads of textile 72 maintain structural integrity in textile 72, notwithstanding the ability of textile 72 to swell in thickness. If the fluid causing that swelling is vented to the exterior of sheet material 40, as for example by opening valve 32, then the warp threads and the weft threads of textile 72 draw first layer 42 back toward second layer 46, closing gap G and returning textile 72 or matrix 50 to the resting thickness T_{R} thereof. Then an article incorporating sheet material 40 can be compressed for transport or storage.

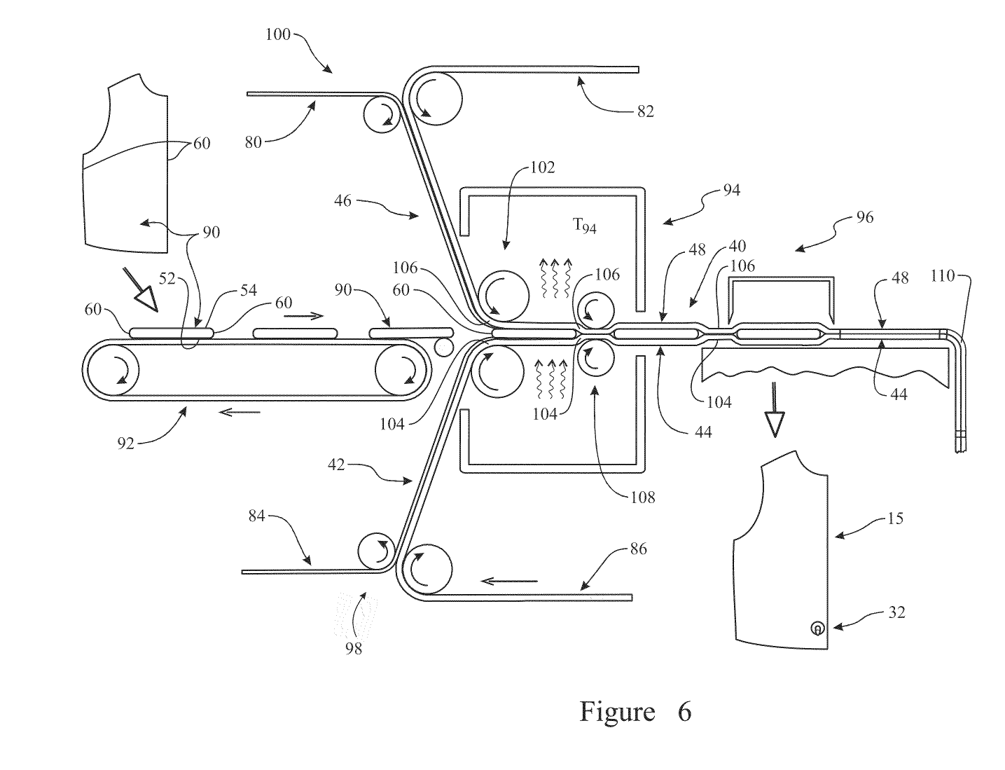

FIG. 6 is a schematic diagram illustrating an embodiment of a method embodying the present invention for manufacturing an article, such as first front panel 15 of vest 14 of FIG. 1. A sheet of one-piece triple-layer textile, such as textile 72 in FIG. 5, is initially cut into a work piece 90 from which to construct an article with advantageous insulating and cushioning properties. Each work piece 90 has, like matrix 50 in FIG. 2, a first face 52, a second face 54 on the opposite side thereof, and a continuous peripheral edge 60 therebetween that circumscribes work piece 90. Work pieces 90 are fed by a conveyor 92 toward a bonding oven 94.

Also fed toward bonding oven 94 are the pair of fluid-impervious layers that will eventually define the first outer surface 44 and the second outer surface 48 of sheet material 40 from which first front panel 15 of vest 14 will eventually be cut in chopping station 96. These, respectively, are first layer 42 and second layer 46.

To produce first layer 42, fluid-impervious melt-adhesive sealing film 84 is applied to one side of a fabric 86. This may be accomplished as shown in FIG. 6 by rolling film 84 against fabric 86 at a first compression station 98, or in the alternative, the material of film 84 may be applied to fabric 86 by spraying or by passing fabric 86 through a bath of that material. The material of film 84 is so chosen as to bond superficially in the manner discussed in relation to FIG. 5 to first face 52 of work piece 90 while passing through bonding oven 94, and yet remain an air-impervious barrier on first face 52. Fabric 86 is possessed of properties that suit fabric 86 to use in a light-weigh outdoor construction, such as vest 14. For example, if first layer 42 is to be disposed ultimately on the side of vest 14 that faces the person of a wearer, then fabric 86 may be provided with wicking properties so as to absorb and remove from within vest 14 moisture produced by exertions of the wearer. If second layer 46 is to be disposed ultimately on the side of vest 14 that faces the environment, then fabric 82 might advantageously have enhanced ripstop properties, heightened moisture repellant qualities, or a camouflaging or reflecting outer surface.

To produce second layer 46, fluid-impervious melt-adhesive sealing film 80 is applied to one side of a fabric 82. This may be accomplished as shown in FIG. 6 by rolling film 80 against fabric 82 at a second compression station 100, or in the alternative, the material of film 80 may be applied to fabric 82 by spraying or by passing fabric 82 through a bath of that material. The material of film 80 is so chosen as to bond superficially in the manner discussed in relation to FIG. 5 to second face 54 of work piece 90 while passing through bonding oven 94, and yet remain an air-impervious barrier on second face 54. Fabric 82 is possessed of properties that suit fabric 82 to use in a light-weigh outdoor construction, such as vest 14.

Bonding oven 94 is maintained at an elevated temperature T₉₄ that is calculated during the passage of work piece 90, first layer 42, and second layer 46 therethrough to sufficiently soften the material of film 80 and film 84 to enable each to become secured to a respective face of work piece 90. Bonding oven 94 includes a third compression station 102 that urges first layer 42 and second layer 46 against work piece 90 when film 80 and film 84 are in a softened state. Even once thusly secured to work piece 90, first layer 42 includes a circumscribing margin portion 104 that extends beyond peripheral edge 60 of work piece 90, while second layer 46 includes a similar circumscribing margin portion 106 that also extends beyond peripheral edge 60 of work piece 90. As work piece 90, first layer 42, and second layer 46 leave bonding oven 94, margin portion 104 of first layer 42 and margin portion 106 of second layer 46 are continuously sealed directly to each other at a fourth compression station 108. This seal circumscribes peripheral edge 60 of work piece 90, enclosing work piece 90 in an air-impervious casing.

Finally, at cutting station 96 each work piece 90 in the air-impervious casing formed thereabout of first layer 42 and second layer 46 is cut from the layered assemblage. This separates first front panel 15 of vest 14 from a sheet of waste 110 that contains only scraps of first layer 42 and second layer 46. Valve 32 is added to first front panel 15, providing a passageway between the space within front panel 15 and the exterior thereof, as well as a means for selectively closing that passageway. First front panel 15 is then secured to other similarly-structured panels to produce a construction, such as vest 14.

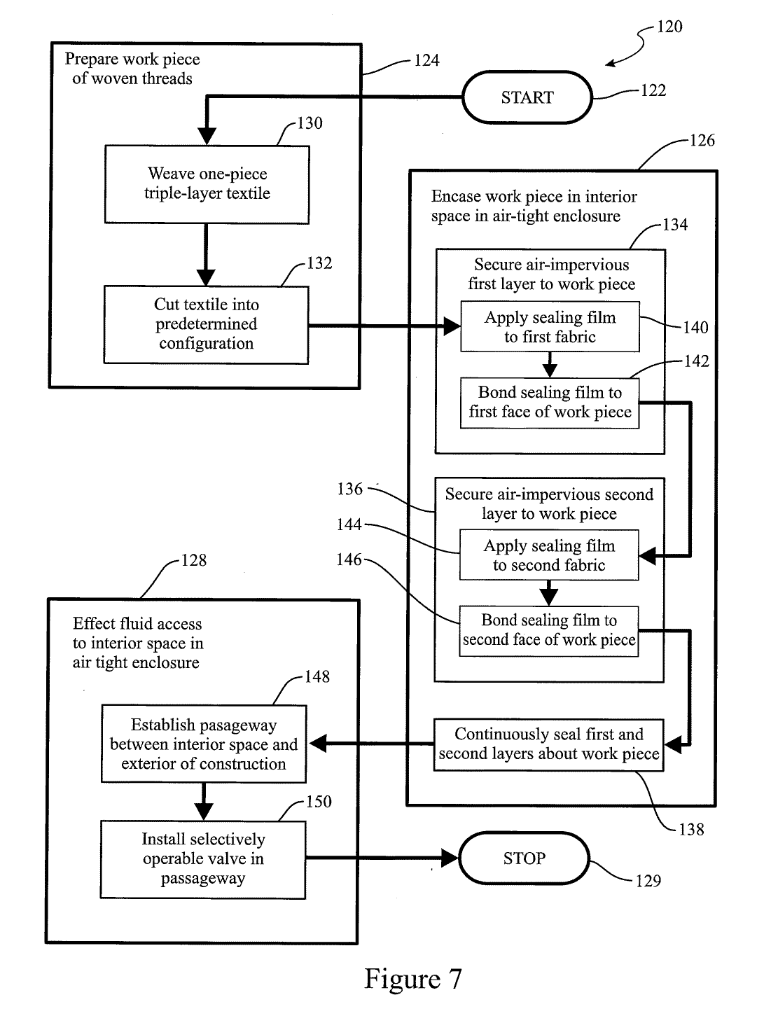

FIG. 7 is a flow chart depicting steps in a method 120 for manufacturing a light-weight construction configured for rugged outdoor use and exhibiting insulating or cushioning properties. Such a method was previously illustrated in FIG. 7.

Method 120 begins at a commencement oval 122. By way of overview, method 120 includes three broad steps. First, as set forth in a subroutine enclosure 124, method 120 involves the step of preparing a work piece of woven threads that has opposed first and second faces and a continuous peripheral edge therebetween that circumscribes the work piece. Second, as indicated in a subroutine enclosure 126, method 120 continues with the step of encasing the work piece in an interior space within an air-tight enclosure. Then, as described in a subroutine enclosure 128, method 120 entails the step of effecting fluid access to that interior space. Method 120 concludes at a termination oval 129.

Each of these three broad steps of method 120 will be discussed in turn.

As indicated in an instruction rectangle 130, the preparation of the work piece of subroutine enclosure 124 requires first the weaving of a one-piece triple-layer textile. An example of such a weaving process was discussed above relative to FIGS. 3A-3F. The resulting textile 72 is illustrated in FIG. 4. Then, as shown in an instruction rectangle 132, the textile of instruction rectangle 130 is cut into a predetermined configuration that is suitable for use in the intended construction. For example, in the method depicted in FIG. 6, work piece 90 assumes a configuration that serves as a basis upon which to develop a panel of a garment, such as first front panel 15 of vest 14.

The encasement of the work piece of subroutine enclosure 126 in an air-tight enclosure, as required in subroutine enclosure 126, is a bit more complex. Two sub-subroutines are involved. First, as set forth in sub-subroutine enclosure 134, an air-impervious first layer is secured to the first face of the work piece. In so doing, a circumscribing margin portion of the first layer is left extending beyond the peripheral edge of the work piece. Then, as set forth in sub-subroutine enclosure 136, an air-impervious second layer is secured to the second face of the work piece. Here also, a circumscribing margin portion the second layer is left extending beyond the peripheral edge of the work piece. The margin portion of the first layer will thus oppose the margin portion of the second layer. Finally, as indicted in an instruction rectangle 138, the margin portion of the first layer is continuously sealed to the margin portion of the second layer. As a result, the work piece of subroutine enclosure 124 becomes housed in an interior space that is defined by the first layer, the second layer, and the continuous circumscribing seal therebetween.

The air-impervious first layer of sub-subroutine enclosure 134 is secured to the first face of the work piece by applying an air-impervious melt-adhesive sealing film to a side of a first fabric to produce the first layer and then by bonding the first layer to the first face of the work piece using the sealing film. These steps of method 120 are called for, respectively, in an instruction rectangle 140 and in an instruction rectangle 142. In FIG. 6, fluid-impervious melt-adhesive sealing film 84 is applied to one side of fabric 86 at first compression station 98 to produce first layer 42, and first layer 42 is bonded against work piece 90 at third compression station 102 in bonding oven 94 when film 84 is in a softened state.

Similarly, the air-impervious second layer of sub-subroutine enclosure 136 is secured to the second face of the work piece by applying an air-impervious melt-adhesive sealing film to a side of a second fabric to produce the second layer and then by bonding the second layer to the second face of the work piece using the sealing film. These steps are called for, respectively, in FIG. 7 in an instruction rectangle 144 and in an instruction rectangle 146. In FIG. 6, fluid-impervious melt-adhesive sealing film 80 is applied to one side of fabric 82 at second compression station 100 to produce second layer 46, and second layer 46 is bonded against work piece 90 at third compression station 102 in bonding oven 94 when film 80 is in a softened state.

Lastly in method 120, as indicated in subroutine enclosure 128, fluid access is effected to the interior space in the air-tight enclosure produced in subroutine enclosure 126. To do so, a passageway is established communicating between the interior space and the exterior of the intended construction. This is indicated in an instruction rectangle 148. Then as indicated in an instruction rectangle 150, a selectively operable valve is installed in the passageway. The valve, like valve 32 in FIGS. 1, 2, and 6, is capable of assuming an open condition wherein fluid communication is afforded between the exterior of the construction and the interior space and a closed condition wherein fluid in the interior space is isolated from the exterior of the article. Loft in the construction is enhanced by placing the valve in the open condition, introducing air into the interior space, and placing the valve in the closed condition.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed is:

1. A sheet material having utility as insulation or cushioning in an article of manufacture, the sheet material comprising:
(a) a fluid-impervious first layer defining a first outer surface of the sheet material;
(b) a fluid-impervious second layer defining a second outer surface of the sheet material on the opposite side of the sheet material from the first outer surface; and
(c) a matrix of woven threads, the matrix having opposed first and second faces and being sandwiched between the first layer and the second layer with the first face of the matrix secured to the first layer and the second face of the matrix secured to the second layer, the matrix being capable of housing in open-cell fashion among the threads thereof a fluid isolated by the first layer and the second layer from the exterior of the sheet material.

2. A sheet material as recited in claim 1, wherein the matrix comprises a triple-layer weave of the threads of the matrix.

3. A sheet material as recited in claim 1, wherein the first layer comprises a fluid-impervious melt-adhesive sealing film carried on a side of a first fabric, and the sealing film is bonded to the first face of the matrix.

4. A sheet material as recited in claim 1, wherein the second layer comprises a fluid-impervious melt-adhesive sealing film carried on a side of a second fabric, and the sealing film is bonded to the second face of the matrix.

5. A sheet material as recited in claim 1, wherein the fluid is a gas.

6. A sheet material as recited in claim 5, wherein the gas is ambient air.

7. An article exhibiting insulating or cushioning properties, the article comprising:
(a) a multi-layered one-piece woven textile having opposed first and second faces and a continuous peripheral edge therebetween circumscribing the textile;
(b) a fluid-impervious laminate first sheet secured to the first face of the textile, the first sheet defining a first outer surface of the article;
(c) a fluid-impervious laminate second sheet secured to the second face of the textile, the second sheet defining a second outer surface of the article; and
(d) a continuous fluid-impervious seal between the first sheet and the second sheet circumscribing the peripheral edge of the textile.

8. An article as recited in claim 7, further comprising a selectively operable valve between the exterior of the article and an interior space containing the textile between the first sheet and the second sheet, the valve being capable of assuming an open condition wherein fluid communication is afforded between the exterior of the article and the interior space and a closed condition wherein fluid in the interior space is isolated from the exterior of the article.

9. An article as recited in claim 7, wherein the first sheet comprises a fluid-impervious melt-adhesive sealing film carried on a side of a first fabric, and the sealing film is bonded to the first face of the textile.

10. An article as recited in claim 9, wherein the first fabric exhibits ripstop properties.

11. An article as recited in claim 7, wherein the second sheet comprises a fluid-impervious melt-adhesive sealing film carried on a side of a second fabric, and the sealing film is bonded to the second face of the textile.

12. An article as recited in claim 11, wherein the second fabric exhibits wicking properties.

13. An article as recited in claim 7, wherein the article is incorporated into a light-weight construction configured for rugged outdoor use and chosen from among the group of constructions comprising personal attire, ground covers, pillows, tenting, tarps, blankets, windscreens, watercraft, and containers for equipment or supplies.

14. A method for manufacturing a light-weight construction configured for rugged outdoor use and exhibiting insulating or cushioning properties, the method comprising the steps:
(a) preparing a work piece of woven threads, the work piece having opposed first and second faces and a continuous peripheral edge therebetween circumscribing the work piece;
(b) encasing the work piece in an interior space within an air-tight enclosure; and
(c) effecting fluid access to the interior space.

15. A method as recited in claim 14, wherein the step of preparing comprises the steps:
(a) weaving a one-piece triple-layer textile; and
(b) cutting the textile into a predetermined configuration suitable for use in the construction.

16. A method as recited in claim 14, wherein the step of encasing comprises the steps:
(a) securing an air-impervious first layer to the first face of the work piece, the first layer including a circumscribing margin portion extending beyond the peripheral edge of the work piece;
(b) securing an air-impervious second layer to the second face of the work piece, the second layer including a circumscribing margin portion extending beyond the peripheral edge of the work piece;
(c) continuously sealing the margin portion of the first layer to the margin portion of the second layer.

17. A method as recited in claim 16, wherein the step of securing an air-impervious first layer comprises the steps:
(a) applying an air-impervious melt-adhesive sealing film to a side of a first fabric to produce the first layer; and
(b) bonding the first layer to the first face of the work piece using the sealing film.

18. A method as recited in claim 17, wherein the first fabric exhibits ripstop properties.

19. A method as recited in claim 16, wherein the step of securing an air-impervious second layer comprises the steps:
(a) applying an air-impervious melt-adhesive sealing film to a side of a second fabric to produce the second layer; and
(b) bonding the second layer to the second face of the work piece using the sealing film.

20. A method as recited in claim 19, wherein the second fabric exhibits wicking properties.

21. A method as recited in claim 14, wherein the step of effecting comprises the steps:
(a) establishing a passageway communicating between the interior space and the exterior of the construction; and
(b) installing in the passageway a selectively operable valve capable of assuming an open condition wherein fluid communication is afforded between the exterior of the construction and the interior space and a closed condition wherein fluid in the interior space is isolated from the exterior of the article.
